(19) United States
(12) Patent Application Publication
(10) Pub. No.: US 2025/0389746 A1
(43) Pub. Date: Dec. 25, 2025

(54) Method and System for Measuring the Speed of Vehicles in Road Traffic

(71) Applicant: Breuer Nachrichtentechnik GmbH, Bonn (DE)

(72) Inventors: Mykhaylo Filipenko, Kleinmachnow (DE); Tobias Fischer, Erlangen (DE); Markus Hantschmann, Potsdam (DE); Shiyue Zhang, Schriesheim (DE)

(21) Appl. No.: 18/881,230

(22) PCT Filed: Jul. 6, 2023
(86) PCT No.: PCT/EP2023/068724

§ 371 Date: Jan. 3, 2025

(30) Foreign Application Priority Data
Jul. 7, 2022 (EP) 22183474.0

(51) Int. Cl. G01P 3/38; G06T 7/246; G06T 7/73

(52) U.S. Cl. CPC G01P 3/38; G06T 7/248; G06T 7/74; G06T 2207/10016; G06T 2207/30252

(57) ABSTRACT

The invention relates to a method for measuring the speed of a vehicle in road traffic, including the following method steps: generating a plurality of captured images of a vehicle; identifying features of the vehicle within the captured images determining the position Pi of the identified features checking whether the identified features are situated within or outside a first capture area performing a coarse measurement for a speed vector of a vehicle. The coarse measurement is based on the position of the features that are situated within the first capture area (B1); checking whether the speed vector determined during the course measurement represents an exceedance of a specified maximum speed; and performing a fine measurement for the speed vector if an exceedance of the specified maximum speed was determined during the preceding check.

### CROSS-REFERENCE TO RELATED APPLICATIONS

This application is the United States national phase of International Patent Application No. PCT/EP2023/068724 filed Jul. 6, 2023, and claims priority to European Patent Application No. 22183474.0 filed Jul. 7, 2022, the disclosures of which are hereby incorporated by reference in their entireties.

### BACKGROUND OF THE INVENTION

### Field of the Invention

The present invention relates to a method for measuring the speed of vehicles in road traffic and to a corresponding device for measuring speed.

### Description of Related Art

Different approaches for determining vehicle speeds are known from prior art. These are used in particular to increase traffic safety and reduce the number of traffic accidents in the long term.

The provision of efficient, precise and cost-effective measurement methods offers the advantage that they can be used in all traffic sections where traffic accidents are frequently observed. The use of nationwide speed measurement procedures has the direct effect of increasing road users' awareness of compliance with the speed limit and making it easier for the competent authorities to punish speeding offenders.

Up to now, both active and passive measurement methods have been used to determine vehicle speed.

In the active methods, the measuring device emits electromagnetic radiation which is reflected by a vehicle and then detected by the measuring device. The speed of the vehicle can be concluded on by evaluating the reflected radiation. For example, the signal propagation time of the radiation emitted by the measuring device and reflected by the vehicle can be evaluated. Alternatively, triangulation methods can be used to calculate the position of a vehicle at two different points in time and to determine the vehicle speed from the difference between the calculated positions and the time difference between the individual measurements.

One disadvantage of active methods is that they have a relatively high energy requirement, which makes it difficult to operate the corresponding measuring devices independently, as the provision of the required energy by batteries, accumulators and/or solar cells is much more demanding. In addition, the measuring devices for active speed measurement are often associated with high acquisition costs.

In addition to the active measuring methods, passive measuring methods for speed measurement are also known in which the measuring device does not emit any radiation. With some of the passive measurement methods mentioned, only the time a vehicle needs to cover a specified distance is measured. This is why such methods are often referred to as distance-time methods. Here, light barriers, brightness sensors or pressure sensors can be used to generate a signal when a vehicle passes. One disadvantage of the distance-time methods described above is that they often require construction work, which means that the initial acquisition and commissioning costs can be relatively high. In addition, a separate camera usually has to be used for recording the vehicle data and/or person-specific data in the distance-time methods. A further disadvantage of the methods described above is that a subsequent assignment of measured values and a subsequent verification of the calculated measured values are practically impossible. This is particularly problematic if a driver denies having allegedly exceeded the speed limit.

As an alternative to the distance-time method, it is also possible in principle to calculate the speed of a vehicle in a purely camera-based manner. Here, a camera will be used to capture a specific section of the route. The camera has at least one image sensor, which is typically designed as a CCD sensor or a CMOS sensor. By using specific feature recognition algorithms, it is possible to detect one or more distinctive features of a vehicle (for example, a corner of a license plate or windshield) and determine the position of this feature at the time of a first image capturing. The camera is usually calibrated in such a way that it allows an assignment between the individual pixels of the image sensor and the position of the feature within the observed section of the route. The same feature of the vehicle can be recognized in the second captured image and the position of this feature can be determined at the second point in time by a renewed detection of the vehicle by the image sensor at a second point in time. If the position of a feature is known at the first time and at the second time and if the time interval between the individual images is also known, the speed can be calculated for a feature or for the vehicle.

It is also possible for a camera system to have two image sensors that record a vehicle from different perspectives and then enable the three-dimensional position of a feature to be determined.

One problem with the camera-based methods discussed above is that errors in feature recognition can significantly impair the measurement result. In particular, it can happen that several features are recognized in one captured image, which can be assigned to different vehicles. In this case, the speeds of several vehicles are included in the measurement in an undesirable way, which leads to a distorted result.

In addition, one challenge with the measurement methods known to date is to enable efficient calculation of the vehicle speed.

### SUMMARY OF THE INVENTION

Based on the above problem, it is the object of the present invention to provide a method for measuring the speed of vehicles in road traffic which is particularly precise, robust and efficient.

In order to solve the aforementioned problem, the present invention proposes a method for measuring the speed of a vehicle in road traffic, wherein the method is carried out using a measuring device comprising at least one image sensor, a memory unit, a computing unit and a communication unit, and wherein the method comprises the following steps:
generating a plurality of captured images of a vehicle;
identifying features of the vehicle within the captured images;
determining the position Pi of the identified features;
checking whether the identified features are situated within or outside a first capture area;
performing a coarse measurement for a speed vector of a vehicle, wherein the coarse measurement is based on the position of the features that are situated within the first capture area;
checking whether the speed vector determined during the course measurement represents an exceedance of a specified maximum speed; and
performing a fine measurement for the speed vector if an exceedance of the specified maximum speed was determined during the preceding check.

With the method according to the invention, the vehicle speed is determined particularly precisely and efficiently, whereby the risk of measurement errors is significantly reduced. A further significant advantage is that the calibration of the device can be continuously adjusted during an ongoing measurement, which enables robustness against external influences (e.g. thermal or mechanical effects).

In addition, the method according to the invention offers the advantage that a subsequent assignment of the individual vehicles and the associated measurement is possible. This allows a subsequent verification of the measured values determined. As explained above, this is particularly advantageous in cases where a driver denies having allegedly exceeded the speed limit.

The method according to the invention enables a coarse measurement of the speed vector to be carried out first, making optimum use of the available computing resources, and a fine measurement to be carried out only in those cases in which speeding has been detected, which is associated with a higher computing effort. In this way, the more precise fine measurement is only carried out when it is required.

If, for example, the specified maximum speed on a section of road is 100 km/h and the speed determined during the rough measurement is only 80 km/h, a detailed speed measurement is not carried out. If, on the other hand, a speed of 110 km/h is determined during the rough measurement, it is advantageous to carry out the fine measurement in order to obtain a particularly precise measurement result and to determine the speeding exactly.

The measurement method referred to as “coarse measurement” in the context of the present invention may also be referred to as a “first measurement method”, while the measurement method referred to as “fine measurement” may be referred to as a “second measurement method”.

The captured images can be generated by a single image sensor. If several image sensors are provided, the captured images can be generated by several image sensors.

The term speed vector used in the context of the present invention emphasizes that the speed of a vehicle can be measured in several dimensions. Depending on the embodiment of the present invention, the speed vector can be three-dimensional, two-dimensional or one-dimensional.

The coarse measurement of a speed vector describes a first measurement method in which the computational effort is relatively low, while the fine measurement uses a second measurement method in which the computational effort is higher, but the measurement accuracy is increased compared to the coarse measurement. For example, it may be sufficient for the coarse measurement that only two captured images are used and the features contained therein are evaluated, while for the fine measurement all available captured images are used for the measurement. In the context of the present invention, however, different methods can be used for the coarse measurement and the fine measurement, as long as a higher measuring accuracy can be achieved by the fine measurement than by the coarse measurement.

According to some embodiments of the present invention, it may be provided that two image sensors are provided and that the above-mentioned coarse measurement comprises the following method steps:
generating a first captured image at a first point in time using a first image sensor and generating a second captured image at the first point in time using a second image sensor;
capturing a third image at a second point in time using the first image sensor and capturing a fourth image at the second point in time using the second image sensor;
identifying features in the individual images;
matching the features in the images captured by the first image sensor against the features contained in the images captured by the second image sensor at the same point in time, wherein those features which are only contained in the images captured by the first image sensor or in the images captured by the second image sensor are discarded;
comparing the corresponding features in the images captured by the first image sensor with the features in the images captured by the second image sensor with regard to their epipolar geometry, wherein those features for which the epipolar conditions are not fulfilled are discarded;
matching the features in the images captured by the first image sensor, whereby those features which are not contained in both images captured by the first image sensor and those features which are not contained in both images captured by the second image sensor are discarded;
determining features whose position has remained unchanged from the first point in time to the second point in time and removing those features whose position has remained unchanged;
determining the spatial position of the features using a triangulation method;
determining a velocity vector for each feature that has not previously been discarded;
determining the speed for each feature from the speed vector determined for the corresponding feature;
determining an average speed of the vehicle by averaging the determined speeds for each feature.

The two image sensors can, for example, be arranged side by side (in the sense of a left and a right image sensor) or above one another (in the sense of an upper and a lower image sensor).

The two image sensors each capture an image at a first point in time and a second point in time. However, the generation of captured images is not limited to capturing images at exactly two points in time. Rather, the image sensors can also be configured to capture a plurality of images, so that information of a plurality of images can be used for speed determination. In this respect, the above-mentioned two points in time are to be understood as a minimum, so that the individual image sensors generate at least two captured images according to the embodiments of the invention described above.

The first image sensor and the second image sensor together can represent a camera system. Here, the image sensors can be arranged in a housing. In addition, the camera system can comprise image capturing optics which are each arranged between an image sensor and the image capturing area to be monitored (in which the vehicles are to be captured).

According to some embodiments, specific features are detected in each of the captured images generated by the image sensors. For this purpose, one can rely on one of several feature detection methods (also called feature recognition algorithms) known from prior art. For example, the SIFT (Scale Invariant Feature Transform), SURF (Speed Up Robust Feature), BRIEF (Binary Robust Independent Elementary Feature) or ORB (Oriented FAST and Rotated BRIEF) methods can be used to detect the features. A Harris Corner Detector can also be used for feature recognition in order to detect distinctive corner points within an image.

The features can be a prominent point within the image. For example, a corner point within an image that has a particularly high contrast can be detected. Alternatively, the feature can also refer to a line or another geometric shape (e.g. a rectangle or a trapezoid). In practice, several tens, several 100, several 1,000 or even more features can be recognized within one image or belong to the same vehicle. Since the processing of a large number of features increases the computing effort and consequently the computing time required on the one hand and reduces the inaccuracy due to expected errors in the recognition of individual features in the captured images on the other hand, a specific selection of the determined features is performed within the framework of the present invention before the speed of the vehicle is ultimately determined on the basis of the determined features. This significantly increases the efficiency of the measurement process on the one hand and reduces the susceptibility to errors on the other hand.

During selection, the features captured by the first image sensor are matched against the features captured by the second image sensor. If a feature, for example a prominent point, was detected at a first time t1 in the first image and this feature does not appear in the second image (also captured at time t1), this feature is discarded for further processing. After this process step, only those features remain that are actually contained in the images that were captured by both image sensors at the same time. In this way, an initial consistency check is performed, whereby all inconsistent features are not taken into account for the speed calculation.

A feature known in a captured image can be described by a vector, for example. Ideally, two corresponding features in two images should have identical values. As a result, two features must be considered as identical, if their feature vectors are identical. In practice, however, matching two features can be performed such that not only the identity of two feature vectors allows to conclude on the same feature, but that first a distance between two feature vectors is calculated and the two features are assumed to be identical, if the distance between the feature vectors is smaller than a preset threshold. For a calculation of the distance between two feature vectors, the Hamming distance or the Euclidean distance can be used.

In addition, the features in the captured images generated by the first image sensor and the second image sensor at the same point in time are compared with respect to their epipolar geometry. If the epipolar condition for two features is met, it is assumed that these points are consistent. In this case, the features are retained. If the epipolar condition for two features is not met, this indicates that the features are inconsistent, so that the inconsistent features are removed and are neglected during the later speed determination. In general, the epipolar condition for two points is met, if the following equation (also referred to as epipolar equation) is met:

$${p}_{2}^{T} {Fp}_{1} = 0$$

$$or$$

$$( \begin{matrix}{x}_{2} & {y}_{2} & 1\end{matrix} ) ( \begin{matrix}{f}_{11} & {f}_{12} & {f}_{13} \\ {f}_{21} & {f}_{22} & {f}_{23} \\ {f}_{31} & {f}_{32} & {f}_{33}\end{matrix} ) ( \begin{matrix}{x}_{1} \\ {y}_{1} \\ 1\end{matrix} ) = 0.$$

Here, p₁ refers to a point in the first image, p₂ refers to a point in the second image, and F refers to the fundamental matrix. The fundamental matrix is calculated from the geometric relation of the two cameras (translation and rotation) and the intrinsic camera parameters. It describes an imaging rule between coordinate systems of both cameras. If the features represent individual points, it can be determined immediately by checking the above condition, whether the two features correspond to each other. If the features represent geometric shapes, it is possible to compare, for example, one point or a plurality of points of the geometric shape of each of the respective images with respect to their epipolar geometry. For example, in case of a line, the check of the epipolar condition can be applied to the two end points of the line in order to check, whether the lines detected in two images describe the same feature.

In practice, the fulfillment of the epipolar condition can be defined in such a way that the product of p₂ (transposed), the fundamental matrix F and p₁ is not exactly equal to 0, but is smaller than a specified limit value.

Furthermore, the features determined in two consecutive images captured by an image sensor are checked for consistency. Those features that are not contained in both images captured by the first image sensor or the second image sensor are discarded. As explained above, an image sensor can be designed to generate more than two images. In this case, it may be necessary to discard those features that are not contained in all images generated by an image sensor.

In order to further increase the efficiency of the method according to the invention, the features whose positions have remained unchanged over time are also determined in the present invention, wherein these “constant” features are discarded. This further reduces the total number of features used for speed determination to those features that actually move between the first and second points in time and which therefore contain information about the vehicle speed. Thereby, it can be prevented in an advantageous way that features that can be assigned to a building or road marking, for example, are unnecessarily included.

After those features that are considered inconsistent have been discarded, the spatial position of the features is determined using a triangulation method. Triangulation methods are known from prior art and enable the position of an object to be determined using trigonometric relationships.

As soon as the position of a feature is determined at the first and second points in time, a speed vector is determined for each feature. The time difference between two consecutive images and the displacement vector (also known as the movement vector) for each (consistent) feature can then be used to determine the speed for each of the (consistent) features. The time difference between two images can generally be assumed to be known. This can be derived, for example, from the image capturing frequency of the image sensors used. If the image sensors are used with an image capturing frequency of 20 fps (frames per second), it can be deduced therefrom that the time difference between two consecutive images is 50 ms. If two images from a video sequence are used to determine the speed, which are ten frames apart, it can be concluded that the time difference between the images used is 500 ms. In this respect, a speed vector can be determined as the quotient of a displacement vector, which describes the movement of a feature between two images and is defined by the start position and the end position of the feature, and the time difference between the two images. According to the present invention, the speed vector can therefore be determined for the respective feature by determining the quotient of a displacement vector, which describes the movement of a feature between two images and is defined by the start position and the end position of the respective feature, and the time difference between two images. The speed can be determined for one feature at a time by determining the magnitude of the speed vector for the corresponding feature.

Thereafter, an average speed of the vehicle can be determined according to the coarse measurement, by calculating a average value from the individual speeds determined for each feature. For example, an arithmetic average value can be formed from the individual speed values or the median value can be determined from the individual speed values. Here, for example, only those features or the speed values for those features may be included that were previously considered to be consistent and were not discarded.

According to one embodiment of the invention, it may be provided that the coarse measurement additionally comprises the following method step:
checking the consistency of the speed vectors using a RANSAC method, wherein those speed vectors are discarded that were rated inconsistent.

RANSAC methods (Random Sample Consensus method) are generally known from prior art. Using a RANSAC method makes it possible to detect outliers in a set of measurement data. In this case, while taking into account the average value of the recorded measurement data and a preset tolerance range, those measurement values are identified that are outside the preset tolerance range.

As an alternative to the RANSAC method, it is also possible, according to the invention, to use a special variant of the DBScan method. Here, the determined 3D points and speed vectors are “clustered” simultaneously in a 6-dimensional space, i.e. consistent groups are formed with regard to a 6-dimensional metric. Each consistent group corresponds to a vehicle moving in the visible field of view.

A consistent group that is visible over several consecutive images, but at least over two consecutive images, is also referred to as a “cluster”. The measured speed value for a cluster is formed as soon as the geometric center of gravity thereof falls below a fixedly defined distance from the measuring device. Here, the speed values of all points belonging to all consistent groups of the cluster are used.

In coarse measurement, the consistent groups can be combined into a cluster by determining the geometric center of gravity for each consistent group and checking whether it has moved by the distance corresponding to the speed vector of the respective consistent group within the corresponding time difference between the frames.

According to one embodiment of the method according to the invention, it can be provided in coarse measurement that a time signature (often also referred to as a time stamp or digital time stamp) is generated during the capture of each image, which is attached or assigned to the image. With the additional time signature, the exact time at which an image was actually captured can be precisely defined. In this way, the accuracy of the method according to the invention can be increased.

According to one embodiment of the method according to the invention, it may also be provided that the coarse measurement comprises the following method step:
checking the consistency of the direction of the individual speed vectors, wherein the angle between the individual speed vectors and a predetermined reference line is determined in each case and an angle average value is determined from the determined angle values and those speed vectors are regarded as inconsistent for which the difference between the determined angle and the angle average value is greater than a predetermined limit value, and wherein those speed vectors which are regarded as inconsistent are discarded.

In particular, the reference line can run parallel to the monitored lane. In general, it is to be expected that the detected features of the vehicle have a direction of movement that is essentially parallel to the road. If the direction of movement shows a clear deviation from the reference line (and consequently the determined angle value exceeds a specified limit value), this can be taken as an indicator that a determined speed vector is inconsistent. This approach allows the individual speed vectors, which are to be regarded as inconsistent, to be discarded. The accuracy of the method can be further increased by subsequently limiting it to the consistent speed vectors for the subsequent velocity calculation. At the same time, the susceptibility to errors of the measurement procedure is reduced.

Furthermore, according to the present invention, it may be provided that the coarse measurement comprises the following method step:
checking the consistency of the amount of the individual speed vectors using a RANSAC method, wherein those speed vectors are discarded that were regarded as inconsistent.

While the consistency of the direction of the speed vectors was checked in the method step described above, the consistency of the amount is checked in this method step.

Here, outliers determined by the RANSAC method used are ignored in the subsequent calculation of the vehicle speed. A limit value can be defined, whereby those measurement values that exceed the limit value are regarded as outliers. By checking the consistency of the vector amounts and by discarding inconsistent values, the efficiency of the present measurement method can be further increased, while simultaneously reducing the susceptibility to errors.

According to a preferred embodiment of the invention, it may be provided that the coarse measurement comprises the following method step:
comparing the corresponding features in the images captured by the first image sensor at the first point of time and at the second point of time and comparing the corresponding features in the images captured by the second image sensor at the first point in time and at the second point in time with regard to their epipolar geometry, whereby those features for which the epipolar conditions are not fulfilled are discarded.

Thereby, the number of features used for the final speed determination can be further reduced, wherein only the consistent features are considered for the speed determination. In this manner, the efficiency of the method according to the invention can be further increased and simultaneously the precision of the method can be enhanced, since significantly fewer measurement values have to be used for the final speed determination and because inconsistent measurement values remain unconsidered in the speed determination.

When checking whether the speed vector determined during the coarse measurement represents an exceedance of a specified maximum speed, the magnitude of the speed vector can be compared with the specified maximum speed. If the magnitude of the speed vector is greater than the specified maximum speed, the speed vector determined during the coarse measurement represents speeding and a fine measurement is then carried out.

In the case of fine measurement, on the other hand, it may be necessary to evaluate significantly more data, which means that a more precise measurement result can be expected. For example, the fine measurement may take into account all captured images that depict a vehicle (completely or at least partially) within the first capture area.

For example, only the position of the features in two images can be used for the coarse measurement, while the position of the features in 20 or 30 images can be used for the fine measurement, which is only carried out if the speed limit is exceeded. The corresponding features for the fine measurement can be determined retrospectively using the coarse measurement method. This is possible because the corresponding captured images are stored in the working memory, even if they are not processed during the coarse measurement.

In the method according to the invention, a first capture area is defined and it is checked whether all of the features recognized in a captured image are located in the defined first capture area. If some features are outside the first capture area, they are discarded and are not taken into account in the speed measurement or speed calculation. This reduces the risk of features being taken into account in the speed measurement that can be assigned to different vehicles. As a result, the measurement inaccuracies of the method are reduced and the robustness of the method against measurement errors is increased.

The first capture area can be defined in different ways. In particular, the first capture area can be defined as two numerical values that define the limits of the first capture area. For example, the values z1 and z2 can define the limits of the first capture area, whereby the values z1 and z2 define the distances to a reference point along a first axis (z-axis). The first axis can run parallel to the longitudinal direction of the section of the route captured by a camera, or also parallel to a vector that runs orthogonally to the sensor surface of the camera's image sensor, whereby in the latter case the reference point can be arranged on the sensor surface. For example, z1 and z2 can be defined as follows: (z1, z2)={(25 m, 35 m), (20 m, 30 m), (15 m, 25 m)}.

After all features that lie outside the first capture area have been discarded, a velocity vector is determined for each of the features that were not discarded. The position of the respective feature within the first captured image taken at the first point in time and within the second captured image taken at the second point in time is determined, as well as the time difference between the two captured images. In addition, an average velocity vector is determined from the individual velocity vectors. For example, the arithmetic mean or the median value can be used for this purpose.

According to a preferred embodiment of the method according to the invention, it may be provided that the performance of the fine measurement for the velocity vector comprises the following steps:
storing those captured images F which have features within the first capture area, wherein a total of N captured images are stored;
assuming a constant velocity vector v of the vehicle in the first capture area;
for all captured images Fᵢ with i=2, . . . , N:
(a) calculating a position \hat{P}i,ⱼ for each of the features j recognized in the captured image Fᵢ, from the previously determined position of the feature in the previous captured image Fᵢ₋₁ and the assumed velocity vector v, according to:

$${\hat{P}}_{i , j} = {P}_{i - 1 , j} + v \cdot Δ t ,$$

wherein \hat{P}_{i,j} describes the position of the feature j detected in the captured image Fᵢ during fine measurement, P_{i-1,j} describes the position of the feature j detected in the captured image Fᵢ₋₁ during coarse measurement, v describes the assumed speed vector of the vehicle in the first capture area, Δt describes the time difference between the individual captured images;
(b) calculating an average distance value between the positions P_{i,j} of the individual features j determined during the coarse measurement and the positions \hat{P}_{i,j} of the individual features j determined during the fine measurement;
(c) changing the speed vector v and repeating steps (a) and (b) until a predefined termination criterion is reached.

In this embodiment of the present invention, the speed measurement is calculated on a larger amount of data compared to the coarse measurement. The iterative approach enables precise calculation of the speed vector. Steps (a) and (b) are repeated until a specified quality is achieved. As will be explained below, different termination criteria can be defined in the context of the present invention.

As explained above, the speed vector v can be three-dimensional, two-dimensional or one-dimensional. For example, a speed vector v can be assumed, which was determined during the coarse measurement. If a speed of 105 km/h was determined during the coarse measurement and the maximum permitted speed is 100 km/h, the fine measurement can be carried out at a speed of 105 km/h, which is assumed to be constant. This speed can be changed within a predefined range (e.g. 105 km/h +/−5 km/h). The change can be made in steps of 1 km/h, for example. Depending on the defined termination criterion, the iterations can be continued until either all predefined speed values have been run through or until a predefined termination condition occurs.

The time difference At can be calculated in particular from the frame rate of the camera system used. For example, if the camera system is set up to capture 25 images per second, the time difference At between two consecutive image captures is 40 ms.

When changing the velocity vector v, the position P_{i-1,j} of the corresponding features determined during the coarse measurement can be replaced in particular by the position \hat{P}_{i,j} of the features determined during the fine measurement, provided that the calculated mean distance value is less than the mean distance value calculated on the basis of the position determined during the coarse measurement.

According to one embodiment of the method according to the invention, it may be provided that the termination criterion is defined in such a way that the mean distance value is not reduced after a change in the speed vector. As soon as it is detected that a change in the speed vector does not lead to any additional improvement in the measurement, the iterative procedure can be completed and the speed vector for which the smallest distance value was determined can be output as the result of the fine measurement. Further iterations can be considered unnecessary in this case, so that these are avoided to prevent increased computational complexity (i.e. the required computing time or computing effort). When implementing this embodiment, various gradient-based optimization methods, such as the so-called “gradient descent” method or the ADAM method, can also be used.

According to a further advantageous embodiment of the method according to the invention, it may be provided that the termination criterion is defined in such a way that the change in the mean distance value after a change in the speed vector is less than a predetermined limit value. The previously calculated average distance value is regarded as an indicator of the accuracy of the determined speed. As soon as the distance value from one iteration to the next no longer shows any significant change, the iterative process can be aborted at this point. In this way, an efficient determination of the vehicle speed can be ensured without having to carry out additional iterations, which would probably not lead to a significant increase in measurement accuracy anyway.

Furthermore, the method according to the invention may provide that the termination criterion is defined in such a way that steps (a) and (b) have previously been carried out for a predetermined set of speed vectors. This ensures that all speed values within a specified speed range are checked iteratively before a final measurement result is determined and output. In principle, it is possible that after a few iterations, the measurement data could give the impression that the optimum result has already been achieved after the few iterations, as, for example, the distance value shows no significant change after a few iterations. However, it is quite possible that the optimum result of the measurement will only be determined in one of the following iterations. This means that running through all speed vectors from a previously defined range provides particularly reliable measurement results. For example, a speed of 130 km/h may have been determined during the coarse measurement, while several equidistant speed values in the range of 120 km/h to 140 km/h are checked during the fine measurement in order to achieve a particularly precise measurement result. The speed values in the specified range can be run through in steps of 0.1 km/h, 0.2 km/h, 0.5 km/h or 1 km/h, for example, whereby an average distance value is calculated for each speed value.

Different distance values can be used to calculate the average distance value. Preferably, it can be provided that the mean distance value is calculated from a

Euclidean distance between the position P_{i,j} determined during the coarse measurement and the position \hat{P}_{i,j}. The position P_{i,j} determined during the coarse measurement describes the initially determined position. During the iterative process, this can be replaced by the position \hat{P}_{i,j} determined during the fine measurement, provided this leads to a reduction in the mean distance value. In this case, the distance value can be calculated as follows:

$${d}_{euklid , i , j} = \sqrt{{{( {\hat{P}}_{i , j}^{x} - {P}_{i , j}^{x} )}^{2} + {\hat{P}}_{i , j}^{y} - {P}_{i , j}^{y} )}^{2} + {( {\hat{P}}_{i , j}^{z} - {P}_{i , j}^{z} )}^{2}} ,$$

$$, where {\hat{P}}_{i , j}^{x} , {\hat{P}}_{i , j}^{y} and {\hat{P}}_{i , j}^{z}$$

refer to the x, y and z component of

$${\hat{P}}_{i , j} and {P}_{i , j}^{x} , {P}_{i , j}^{y} und {P}_{i , j}^{z}$$

refers to the x, y and z components of P_{i,j}.

To determine the mean distance value, the sum can thereafter be calculated from the individual distance values d_{euklid,i,j}, the individual captured images and all features:

$$S = {\sum }_{i , j} {d}_{euklid , i , j}$$

Following the calculation of S, the assumed speed vector v can be changed iteratively, with S being recalculated after each change. The iterative change of the speed vector v and the calculation of S are repeated until a predefined termination criterion is reached. In the context of the present invention, different termination criteria can be used, as already explained above.

According to a further embodiment of the method according to the invention, it may be provided that the mean distance value is determined from a reprojection error. The reprojection error can be calculated as an alternative to calculating the Euclidean distance as described above. The reprojection error RF per characteristic can be calculated as follows:

$${rf}_{i , j} = {C}^{- 1} \cdot {\hat{P}}_{i , j} - W$$

C denotes the so-called calibration matrix, which enables a conversion from real 3D coordinates to 2D pixel coordinates. The reprojection error indicates how far away the pixel values calculated from \hat{P}_{i,j} Ŵ=C⁻¹. \hat{P}_{i,j} are from the originally recorded pixel values of the relevant feature W=(u, v).

The total reprojection error is then calculated as the sum of all previously calculated reprojection errors:

$$RF = {\sum }_{i , j} {rf}_{i , j}$$

And then minimized, with v and C serving as variation parameters. This has two additional advantages: On the one hand, an inaccurate calculation of the speed is improved and the quality of the speed calculation can be inferred from the covariance. On the other hand, the calibration matrix can also be updated, optimized and its quality checked during operation. This can be done on the basis of one vehicle or several vehicles.

In addition, as a further alternative to varying v (and C), the 3D coordinates of each relevant feature can also be varied in order to achieve an even more precise speed determination. Additional boundary conditions can be set for the 3D coordinates. For example, a variation margin of the x,y coordinates can be limited, as the error in the z direction can be regarded as considerably higher.

Furthermore, it can be required that if the 3D coordinates of a relevant feature are shifted in one captured image, the same shift must also occur in other captured images, since the relative positions of the 3D coordinates cannot change because they belong to a rigid object (a vehicle).

Furthermore, the method according to the invention may provide that the additional variation of the 3D coordinates is carried out as a function of the results of the calculation of the reprojection error. For example, the additional variation of the 3D coordinates can take place if the reprojection error or the covariance is greater than a previously defined limit value.

In addition, the steps of the method according to the invention described above can be repeated by varying algorithm parameters. Here, the previously defined covariance can serve as a termination criterion. Alternatively, the difference in the speed determination described above can also be used as an termination criterion.

Furthermore, a device for measuring the speed of vehicles in road traffic is proposed to solve the above-mentioned problem, the device comprising the following:
an image sensor for generating captured images;
a memory unit for storing the generated captured images;
a computing unit for performing multiple processing steps; and
a communication unit for transmitting measurement data or measurement results to an external server unit, wherein
the computing unit is configured to
   generate a plurality of captured images of a vehicle;
   detect features of the vehicle within the captured image;
   determine the position of the detected features;
   check whether the identified features are situated within or outside a first capture area;
   perform a coarse measurement for a speed vector of a vehicle, wherein the coarse measurement is based on the position of the features that are situated within the first capture area;
   check whether the speed vector determined during the course measurement represents an exceedance of a specified maximum speed; and
   perform a fine measurement for the speed vector if an exceedance of the specified maximum speed was determined during the preceding check.

In a preferred embodiment of the device according to the invention, the computing unit can be configured for the fine measurement of the velocity vector to
store those captured images F that have features in the first capture area;
assume a constant speed vector v of the vehicle in the first capture area;
for all captured images Fᵢ with i=2, . . . , N:
(a) calculate a position \hat{P}_{i,j} for each of the features j detected in the captured image Fᵢ, from the previously determined position of the feature j in the previous captured image Fᵢ₋₁ and the assumed velocity vector v, according to:

$${\hat{P}}_{i , j} = {P}_{i - 1 , j} + v \cdot Δ t ,$$

wherein \hat{P}_{i,j} describes the position of the feature j detected in the captured image Fᵢ during fine measurement, P_{i-1,j} describes the position of the feature j detected in the captured image Fᵢ₋₁ during coarse measurement, v describes the assumed speed vector of the vehicle in the first capture area, Δt describes the time difference between the individual captured images;
(b) calculate a mean distance value between the positions P_{i,j} of the individual features j determined during the coarse measurement and the positions \hat{P}_{i,j} of the individual features j determined during the fine measurement;
(c) change the speed vector v and repeat steps (a) and (b) until a predefined termination criterion is reached.

Moreover, in the device according to the invention, it may be provided that the termination criterion is defined in such a way that the mean distance value is not reduced after a change in the speed vector.

It may further be provided that the termination criterion is defined in such a way that the change in the mean distance value after a change in the speed vector is less than a predetermined limit value.

According to a preferred embodiment of the device according to the invention, it can also be provided that the termination criterion is defined in such a way that the computing unit has previously carried out steps (a) and (b) for a predetermined set of speed vectors.

In addition, it can be provided that the mean distance value is calculated from a Euclidean distance between the position P_{i,j} determined during the coarse measurement and the position \hat{P}_{i,j}.

Finally, it can be provided with the device according to the invention that the mean distance value is determined from a reprojection error.

Furthermore, according to the method according to the invention, it can be provided that the first capture area is defined by two points which run along a first axis, wherein the first capture area is bounded by two parallel planes which run orthogonally to the first axis and through the two points, and wherein the first axis runs in particular parallel to the image sensor normal or to the longitudinal axis of a driving section. This allows the first capture area to be defined in a particularly efficient manner, which reduces the computational effort of the entire process.

### BRIEF DESCRIPTION OF THE DRAWINGS

The following invention of the figures is described in more detail below, with the figures showing the following:

FIG. 1 shows an embodiment of the method according to the invention,

FIG. 2 is an example of the device according to the invention,

FIG. 3 is a schematic representation of speed measurement in traffic,

FIGS. 4(a) and 4(b) show a first and a second captured image taken at different times,

FIG. 5 shows various mean distance values calculated for different speed vectors.

### DESCRIPTION OF THE INVENTION

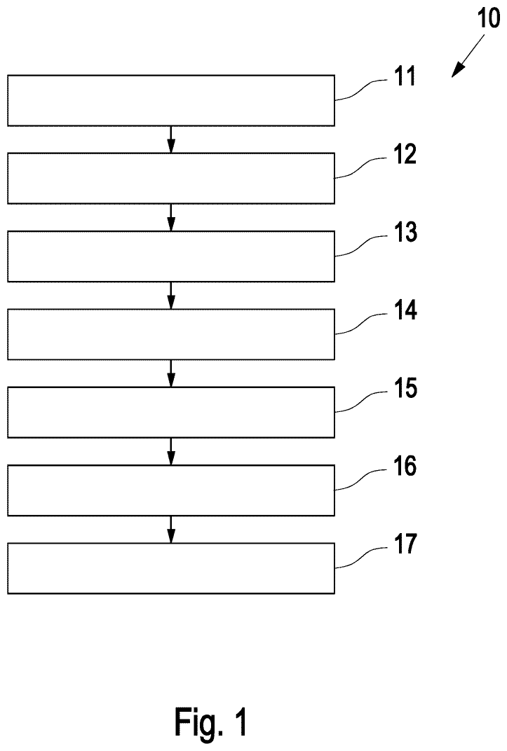

FIG. 1 shows an embodiment of the method 10 according to the invention. In the process according to the invention, a total of seven process steps 11-17 are carried out. In the first method step 11, a plurality of captured image of the vehicle are generated using an image sensor. In the second process step 12, characteristic features are detected in the individual captured images. One of the above-mentioned methods, in particular the SIFT method or a Harris Corner Detector, can be used for this purpose. In the third process step 13, the position of the detected features is determined before the fourth process step 14 checks whether the detected features are inside or outside a first capture area. In doing so, those features that are outside the first capture area can be discarded. Subsequently, in the fifth process step 15, a rough measurement is carried out for a speed vector of a vehicle. The coarse measurement is based on the position of the features located within the first capture area. For example, only two captured images showing a vehicle within the first capture area can be used for the coarse measurement. In principle, it may be sufficient to determine the position of a feature within the first captured image and the second captured image during the coarse measurement. The speed of the vehicle can be determined from the difference between the two positions and the time between the two images as part of the coarse measurement. The computational requirements for the coarse measurement are relatively low. Alternatively, several features can also be evaluated in two captured images, wherein the speed of the vehicle can be calculated, as part of the coarse measurement, from a mean value of the individual speeds determined for each individual feature. When averaging the individual speeds, for example, an arithmetic averaging can be carried out or a median value can be determined. The sixth process step 16 checks whether the speed vector determined during the coarse measurement represents an exceedance of a specified maximum speed. This check can be used to determine whether a new and more precise speed calculation is required compared to the coarse measurement. In cases where the coarse measurement shows that the speed of the vehicle is lower than the specified maximum speed on a particular road section, the result of the coarse measurement is sufficient. In this case, it is not necessary to carry out a fine measurement, as the exact speed value is not relevant. However, if a speed limit has been exceeded, it is necessary to carry out a detailed measurement, as the exact speed value is of particular interest for determining the legal consequences (fine or possible revocation of the driver's license). Therefore, in the seventh method step 17, a fine measurement for the speed vector is performed, if an exceedance of the specified maximum speed was determined during the preceding check. The method according to the invention allows on the one hand an efficient calculation of the vehicle speed, which can take place in real time, and on the other hand a particularly precise calculation of the vehicle speed in special circumstances (exceeding the maximum allowable speed). In this way, the available computational capacities are used in a particularly efficient manner. In addition, the efficient calculation can significantly reduce power consumption. As a result, battery-powered measuring devices can be provided that offer a significantly longer battery life. In addition, the thermal design of the measuring devices can be simplified, as less heat needs to be dissipated overall. Finally, the computationally efficient implementation of the method according to the invention allows a simple and inexpensive computing unit to be used, thereby reducing the overall cost of the measuring device.

Even if the process steps are described above in a specific sequence, it is clear to the person skilled in the art that this sequence is to be understood as purely exemplary and that individual process steps can also be carried out in a different sequence.

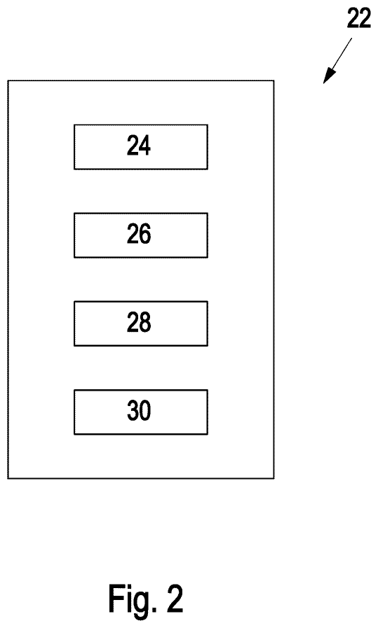

FIG. 2 shows an embodiment of the device 22 according to the invention. The device 22 has an image sensor 24, a memory unit 26, a computing unit 28 and a communication unit 30. The image sensor 24 can be designed in particular as a CCD sensor or a CMOS sensor. In addition, a second image sensor can also be provided, which is not shown in FIG. 2. In particular, the memory unit 26 can be designed as a non-volatile data memory. A CPU (Central Processing Unit) or a GPU (Graphics Processing Unit) can be used in the computing unit 28, for example. The communication unit 30 can in particular have a wireless communication module, wherein in particular a GSM, a UMTS, an LTE or a 5G communication module can be provided. The communication unit is configured to communicate with a central unit and to transmit the recorded measurement data or measured values as required. On the one hand, the measurement results (i.e. the determined vehicle speeds) can be transmitted, together with an image showing the corresponding vehicle and personal data (in particular a license plate number and/or the vehicle owner). On the other hand, the raw data used for the speed calculation can also be transmitted (exclusively or additionally) so that the measurement result can be reconstructed from this raw data at a later point in time if required. This can increase the transparency of speed measurement, which is also expected to increase acceptance of the procedure among citizens.

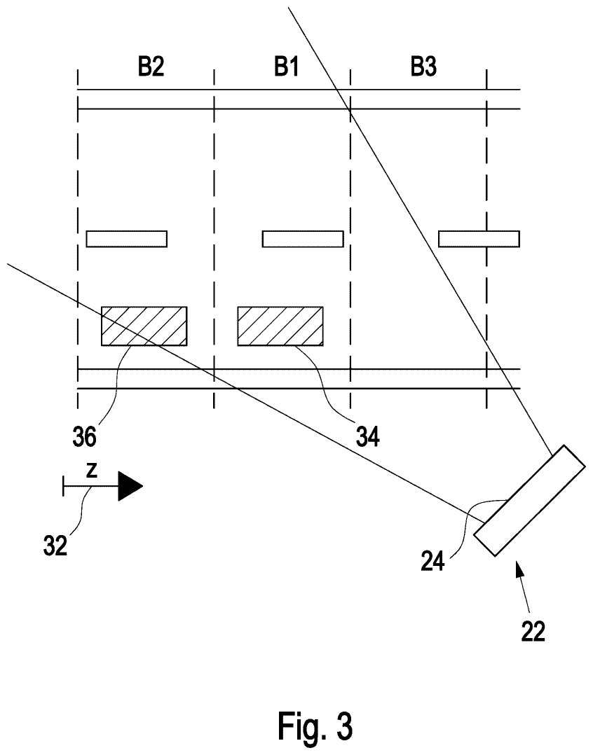

FIG. 3 is a schematic representation of speed measurement in traffic, As shown in this Figure, the measuring device 22 is aligned so that the image sensor 24 can capture an capture area. Alternatively, the image sensor can also be arranged in such a way that an image is generated from a bird's eye view. In the embodiment shown in FIG. 3, the entire capture area is divided into a first capture area B1, a second capture area B2 and a third capture area B3. The second capture area B2 and the third capture area B3 are adjacent to the first capture area B1. The capture areas B1, B2, B3 can be defined by a total of four numerical values (z0, z1, z2, z3), which describe four points along a first axis 32 (also referred to as the z-axis). The three capture areas B1, B2, B3 can be clearly described by the four numerical values mentioned, wherein the capture areas B1, B2, B3 are each bounded by two parallel planes which run orthogonally to the first axis 32 and through the defined points. For example, (z0, z1, z2, z3)=(40, 35, 25, 10), while the individual values indicate the distance to a reference point along the first axis (in meters). In the embodiment shown, the image sensor 24 captures a first vehicle 34 located in the first capture area B1 and a second vehicle 36 located in the second capture area B2. According to the invention, it is provided that all features that are detected outside the first capture area B1 are neglected when determining the vehicle speed. This advantageously means that only those features that are assigned to the first vehicle 34 are taken into account when calculating the speed. This reduces the risk of the characteristics of the second vehicle being included in the speed determination. As a result, the precision and robustness of the measurement process are increased.

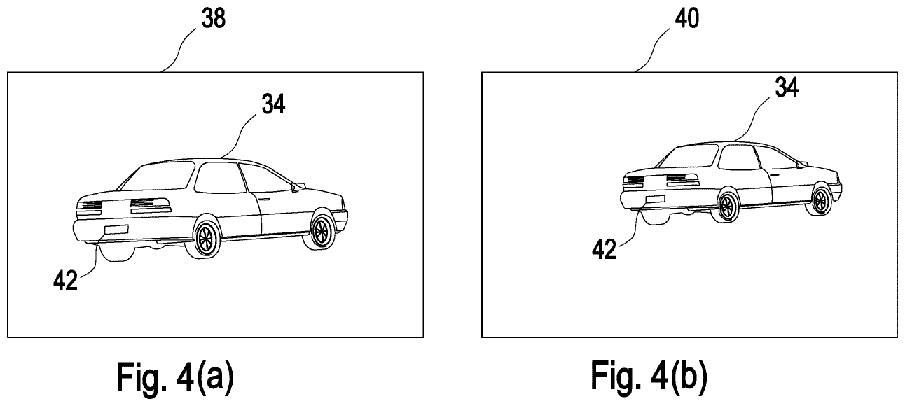

FIGS. 4(a) and 4(b) show two captured images 38, 40, which were generated at two different times. The first vehicle 34 is shown in both captured images 38, 40. A feature 42 is recognized in the captured images, which in the example shown is a corner point of a vehicle license plate. The position of the feature 42 is determined using one of the methods known from the prior art. The speed of the vehicle or the speed of a feature can be determined from the position of the feature 42 in the first captured image 38 and the position of the same feature in the second captured image 40 as well as the time difference between the two captured images 38, 40. In practice, however, not a single feature is typically detected and analyzed, but several hundred features.

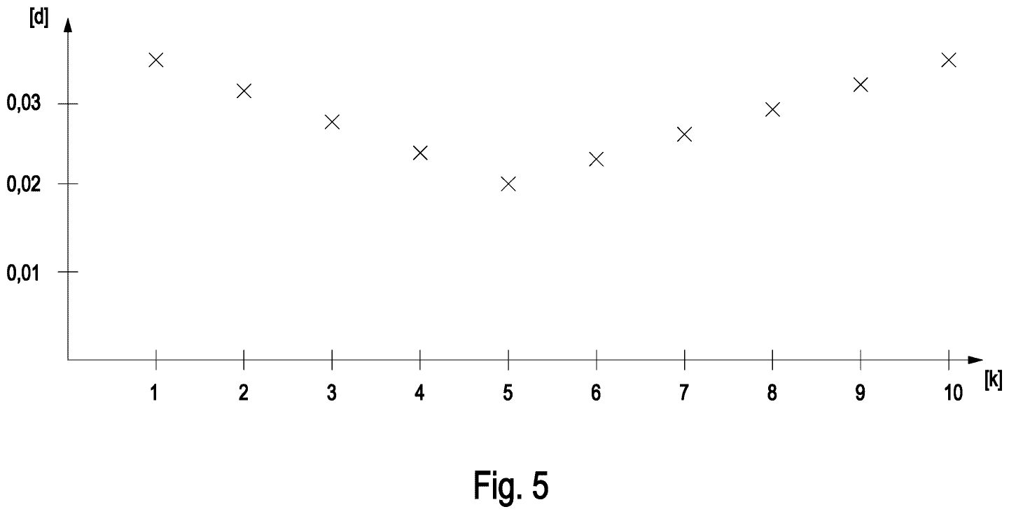

Finally, FIG. 5 shows an average distance value d, which was calculated for various speed vectors Vₖ. FIG. 5 shows the embodiment in which the iterative steps described above were performed for a predefined set of speed vectors. In this design example, ten speed vectors are provided (k=1 to 10), for each of which the mean distance value d was calculated. In the case shown in FIG. 5, it can be seen that the fifth speed vector (k=5) leads to the lowest mean distance value. This shows that the fifth speed vector provides the best result for the speed of the vehicle. As an alternative to the embodiment example shown in FIG. 5, it may be provided that the termination criterion is defined such that the distance value d is only calculated for the first six speed vectors and that the termination criterion is reached after the calculation of the sixth mean distance value d, since the distance value d calculated for the sixth speed vector has no longer decreased compared to the mean distance value calculated for the fifth speed vector.

### LIST OF REFERENCE NUMERALS

10 method according to the invention
11 first method step
12 second method step
13 third method step
14 fourth method step
15 fifth method step
16 sixth method step
17 seventh method step
22 measuring device
24 image sensor
26 memory unit
28 calculation unit
30 communication unit
32 first axis
34 first vehicle
36 second vehicle
38 first captured image
40 second captured image
42 feature
B1 first capture area
B2 second capture area
B3 third capture area

1. A method for measuring the speed of a vehicle in road traffic, using a measuring device comprising at least one image sensor, a memory unit, a computing unit and a communication unit, the method having the following method steps:
generating a plurality of captured images of a vehicle;
identifying features of the vehicle within the captured images
determining the position of the features identified in the captured images;
checking whether the identified features are situated within or outside a first capture area;
performing a coarse measurement for a speed vector of a vehicle, wherein the coarse measurement is based on the position of the features that are situated within the first capture area;
checking whether the speed vector determined during the course measurement represents an exceedance of a specified maximum speed; and
performing a fine measurement for the speed vector if an exceedance of the specified maximum speed was determined during the preceding check.

2. The method according to claim 1, wherein performing of the fine measurement for the velocity vector comprises the following steps:
storing those captured images F which have features within the first capture area, wherein a total of N captured images are stored;
assume a constant speed vector v of the vehicle in the first capture area;
for all captured images Fᵢ with i=2, . . . , N:
(a) calculating a position \hat{P}_{i,j} for each of the features j recognized in the captured image Fᵢ, from the previously determined position of the feature in the previous captured image Fᵢ₋₁ and the assumed velocity vector v, according to:
$${\hat{P}}_{i , j} = {P}_{i - 1 , j} + v \cdot Δ t ,$$
wherein \hat{P}_{i,j} describes the position of the feature j detected in the captured image Fᵢduring fine measurement, P_{i-1,j} describes the position of the feature j detected in the captured image Fᵢ₋₁ during coarse measurement, v describes the assumed speed vector of the vehicle in the first capture area, Δt describes the time difference between the individual captured images;
(b) calculating an average distance value between the positions P_{i,j} of the individual features j determined during the coarse measurement and the positions \hat{P}_{i,j} of the individual features j determined during the fine measurement;
(c) changing the speed vector v and repeating steps and until a predefined termination criterion is reached.

3. The method according to claim 2, wherein the termination criterion is defined in such a way that the distance value is not reduced after a change in the speed vector.

4. The method according to claim 2, wherein the termination criterion is defined in such a way that the change in the mean distance value after a change in the speed vector is less than a predetermined limit value.

5. The method according to claim 2, wherein the termination criterion is defined in such a way that steps and have previously been carried out for a predetermined set of speed vectors.

6. The method according to claim 2, wherein the mean distance value is calculated from a Euclidean distance between the position P_{i,j} determined during the coarse measurement and the position \hat{P}_{i,j}.

7. The method according to claim 2, wherein the mean distance value is determined from a reprojection error.

8. A device for measuring the speed of vehicles in road traffic, comprising:
an image sensor for generating captured images;
a memory unit for storing the generated captured;
a computing unit for performing multiple processing steps; and
a communication unit for transmitting measurement data or measurement results to an external server unit, wherein
the computing unit is configured
to generate several captured images of a vehicle;
to identify features of the vehicle within the captured images;
to determine the position of the detected features;
to check whether the identified features are situated within or outside a first capture area;
to perform a coarse measurement for a speed vector of a vehicle, wherein the coarse measurement is based on the position of the features that are situated within the first capture area;
to check whether the speed vector determined during the course measurement represents an exceedance of a specified maximum speed; and
perform a fine measurement for the speed vector if an exceedance of the specified maximum speed was determined during the preceding check.

9. The device according to claim 8, wherein in the fine measurement of the speed vector, the computing unit is configured
to store those captured images F which have features within the first recording area;
to assume a constant speed vector v of the vehicle in the first capture area;
for all captured images Fᵢ with i=2, . . . , N:
(a) to calculate a position \hat{P}_{i,j} for each of the features j detected in the captured image Fᵢ, from the previously determined position of the feature j in the previous captured image Fᵢ₋₁ and the assumed speed vector v, according to:
$${\hat{P}}_{i , j} = {P}_{i - 1 , j} + v \cdot Δ t ,$$
wherein \hat{P}_{i,j} describes the position of the feature j detected in the captured image Fᵢ during fine measurement, P_{i-1,j} describes the position of the feature j detected in the captured image Fᵢ₋₁ during coarse measurement, v describes the assumed speed vector of the vehicle, in the first capture area, Δt describes the time difference between the individual captured images;
(b) calculate a mean distance value between the positions P_{i,j} of the individual features j determined during the coarse measurement and the positions \hat{P}_{i,j} of the individual features j determined during the fine measurement;
(c) change the speed vector v and repeat steps and until a predefined termination criterion is reached.

10. The device according to claim 9, wherein the termination criterion is defined in such a way that the distance value is not reduced after a change in the speed vector.

11. The device according to claim 9, wherein the termination criterion is defined in such a way that the change in the mean distance value after a change in the speed vector is less than a predetermined limit value.

12. The device according to claim 9, wherein the termination criterion is defined in such a way that the steps and have previously been carried out for a predetermined set of speed vectors by the calculation unit.

13. The device according to claim 9, wherein the mean distance value is calculated from a Euclidean distance between the position P_{i,j} determined during the coarse measurement and the position \hat{P}_{i,j}.

14. The device according to claim 9, wherein the mean distance value is determined from a reprojection error.
